(19) United States
(12) Patent Application Publication
(10) Pub. No.: US 2025/0119221 A1
(43) Pub. Date: Apr. 10, 2025

(54) RSSI-BASED RANGE ACCURACY AUGMENTATION METHOD WITH CSI MAGNITUDE

(71) Applicant: Cisco Technology, Inc., San Jose, CA (US)

(72) Inventors: Jerome Henry, Pittsboro, NC (US); Laurent Pierrugues, San Jose, CA (US); Behrouz Shayesteh, Campbell, CA (US)

(21) Appl. No.: 18/906,804

(22) Filed: Oct. 4, 2024

Related U.S. Application Data
(60) Provisional application No. 63/588,587, filed on Oct. 6, 2023.

(51) Int. Cl. H04B 17/318

(52) U.S. Cl. CPC H04B 17/318

(57) ABSTRACT

In one aspect, a system includes a station device configured to transmit a signal; multiple access point devices in connection with the station device, the multiple access point devices configured to receive the signal transmitted from the station device, wherein the multiple access point devices are configured to convert the signal into a measurable form; and a processing unit operably connected to the multiple access point devices. The processing unit is configured to, for each subcarrier within the signal received by the multiple access point devices, determine a measurement of channel state information including an overall shape of the signal; determine a magnitude distance for each subcarrier; and determine a location of the station device based on a fit of the magnitude distance to a model, wherein the model is based on an environment with one or more obstacles causing an obscuration of the signal.

### CROSS-REFERENCE TO RELATED APPLICATIONS

The present application claims priority to U.S. Provisional Application No. 63/588,587 filed on Oct. 6, 2023, which is hereby incorporated by reference in its entirety.

### BACKGROUND

With the rise of mobile devices, indoor localization has become a crucial challenge. Unlike outdoor localization, which benefits from clear line-of-sight (LOS) signals like those used in the Global Positioning System (GPS), indoor localization deals with complex radio propagation environments, facing issues such as multipath effects, shadowing, fading, and delay distortion that affect indoor localization accuracy. In addition to needing high accuracy, an indoor positioning system must also provide quick estimation and be low in complexity to suit mobile devices.

Indoor localization for Wi-Fi devices have relied on signal-strength (RSSI) based and time of flight (ToF) based techniques. ToF requires joint protocol support (and often cooperation) between the access point (AP) and the station (STA) device, and thus is impractical in many scenarios (e.g. Internet of Things (IoT) asset tracking). Signal strength (RSSI) based techniques are by comparison simpler, but suffer from notoriously poor accuracy. Fingerprinting-based indoor localization has emerged as a solution to meet these needs. However, this approach requires extensive measurements to create a comprehensive database, which is then used for real-time position estimation. Moreover, while RSSI techniques have been improved by also leveraging the Channel State Information (CSI) for the position or range estimation, models based on CSI rely on knowledge of the AP orientation, which is widely error-prone. This limitation is complex to implement in the real world because of its poor accuracy and has drastically limited the adoption of Angel of Arrival (AoA)-based solutions.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an example system for RSSI-based range accuracy augmentation in accordance with an example embodiment.

FIG. 1B illustrates an example system for analyzing and generating magnitude distance determinations for RSSI-based range accuracy augmentation in accordance with an example embodiment.

FIG. 2A illustrates an example environment for RSSI-based range accuracy augmentation in accordance with an example embodiment.

FIG. 2B illustrates an example environment for RSSI-based range accuracy augmentation in accordance with an example embodiment.

FIG. 3 illustrates a routine for RSSI-based range accuracy augmentation in accordance with an example embodiment.

FIG. 4A illustrates example magnitude distance determinations for no walls in accordance with an example embodiment.

FIG. 4B illustrates example magnitude distance determinations for an environment with walls in accordance with an example embodiment.

FIG. 5 illustrates a routine for generating fingerprinting models based on the magnitude distance in accordance with an example embodiment.

FIG. 6 illustrates a routine for cloud-based fingerprinting models in accordance with an example embodiment.

FIG. 7 illustrates a routine for on premise fingerprinting models in accordance with an example embodiment.

FIG. 8 illustrates an example of a computing system, according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

The present disclosure is directed to systems, methods, and techniques to augment RSSI-based location with CSI magnitude data. For example, an STA device's location can be identified based on a magnitude distance (MD) determination, while assuming no particular orientation information from the AP device(s). The techniques described below allow for augmentation to standard RSSI-based ranging by incorporating CSI magnitude, and leveraging the finding that the CSI magnitude can be used to surface the nature of obstacles between the STA device and the AP devices. The disclosed augmented RSSI-based ranging is especially useful in environments where the STA device cooperation is not expected (e.g., non-Fine Timing Measurement (FTM) environments, Internet of Things (IoT) and other asset tracking), but is made difficult to use because of the inaccuracy of RSSI-to-range conversion. Accuracy in device location is increased with the compact addition of a parameter encapsulated within a packet header.

In one aspect, system includes a station device configured to transmit a signal; multiple access point devices in connection with the station device, the multiple access point devices configured to receive the signal transmitted from the station device, wherein the multiple access point devices are configured to convert the signal into a measurable form; and a processing unit operably connected to the multiple access point devices. The processing unit is configured to, for each subcarrier within the signal received by the multiple access point devices, determine a measurement of channel state information including an overall shape of the signal; determine a magnitude distance for each subcarrier; and determine a location of the station device based on a fit of the magnitude distance to a model, wherein the model is based on an environment with one or more obstacles causing an obscuration of the signal.

In another aspect, the multiple access point devices are positioned on a floor map, wherein a location for each access point device is known and recorded; each access point device receives one or more frames from other access point devices within the multiple access point devices; and the processing unit is further configured to determine the magnitude distance from the one or more frames; and construct a fingerprinting model by recording the magnitude distance, wherein the magnitude distance is correlated with an environment represented by the floor map.

In another aspect, the processing unit is further configured to inject the signal into a learning model that determines, for each access point device with a known location, which combination of received signal strength indicators and magnitude distances were recorded as the station device moved locations within a floor map; determine that one or more troughs within the signal correspond to loss of signal strength from an obscuring object within the floor map; and construct a prediction of a new location of the station device at another environment based on how the magnitude distances and the received signal strength indicators change with changing station device locations.

In another aspect, the processing unit is further configured to apply a tree search based on a received signal strength indicator and the magnitude distance; and determine a distance of the station device using a predictive model based on a combination of the received signal strength indicator and the magnitude distance.

In another aspect, the system further includes a cloud server, operably connected to the multiple access point devices via a network. The cloud server is configured to dynamically receive the signal from the multiple access point devices, wherein the multiple access point devices are connected via a first network; determine the magnitude distance for each subcarrier; and modify a fingerprinting model based on the magnitude distance, wherein the fingerprinting model is shared for other access point devices connected via a second network.

In another aspect, the processing unit is further configured to determine the location of the station device based on a fit of the magnitude distance to one or more preloaded models, wherein the one or more preloaded models are based on one or more environments tailored to an environment of the multiple access point devices; and wherein the processing unit is located within at least one of the multiple access point devices.

In another aspect, a packet exchanged between the station device and the multiple access point devices includes a chain identifier, a received signal strength indication, and a magnitude distance per radio chain.

In another aspect, the multiple access point devices are configured to continuously receive the signal and the processing unit is further configured to detect a change within the magnitude distance for a period of time; determine the change within the magnitude distance is associated with a moveable obstacle to yield a determination; and adjust the location determined for the station device based on the determination.

In another aspect, the processing unit is further configured to determine a distance of the station device based on the magnitude distance rather than a position of one or more troughs within the channel state information; and determine a reboot event has occurred based on a shift of the one or more troughs within the channel state information.

In one aspect, a method includes, for each subcarrier within a signal received by multiple access point devices in connection with a station device, determining a measurement of channel state information including an overall shape of the signal; determining a magnitude distance for each subcarrier, wherein the magnitude distance is a total length of a magnitude curve for all subcarriers; and determining a location of the station device based on a fit of the magnitude distance to a model, wherein the model is based on an environment with one or more obstacles causing an obscuration of the signal.

In another aspect, the method further includes positioning the multiple access point devices on a floor map, wherein a location for each access point device is known and recorded, and each access point device receives one or more frames from other access point devices within the multiple access point devices; determining the magnitude distance from the one or more frames; and constructing a fingerprinting model by recording the magnitude distance, wherein the magnitude distance is correlated with an environment represented by the floor map.

In another aspect, the method further includes injecting the signal into a learning model that determines, for each access point device with a known location, which combination of received signal strength indicators and magnitude distances were recorded as the station device moved locations within a floor map; determining that one or more troughs within the signal correspond to loss of signal strength from an obscuring object within the floor map; and constructing a prediction of a new location of the station device at another environment based on how the magnitude distances and the received signal strength indicators change with changing station device locations.

In another aspect, the method further includes applying a tree search based on receiving a received signal strength indication and the magnitude distance; and determining a distance of the station device using a predictive model based on a combination of the received signal strength indicator and the magnitude distance.

In another aspect, the method further includes dynamically receiving, at a cloud server operably connected to the multiple access point devices via a network, the signal from the multiple access point devices, wherein the multiple access point devices are connected via a first network; determining the magnitude distance for each subcarrier; and modifying a fingerprinting model based on the magnitude distance, wherein the fingerprinting model is shared for other access point devices connected via a second network.

In another aspect, the method further includes determining the location of the station device based on a fit of the magnitude distance to one or more preloaded models, wherein the one or more preloaded models are based on one or more environments tailored to an environment of the multiple access point devices.

In another aspect, a packet exchanged between the station device and the multiple access point devices includes a chain identifier, a received signal strength indicator, and a magnitude distance per radio chain.

In another aspect, the method further includes detecting a change within the magnitude distance for a period of time; determining the change within the magnitude distance is associated with a moveable obstacle to yield a determination; and adjusting the location determined for the station device based on the determination.

In another aspect, the method further includes determining a distance of the station device based on the magnitude distance rather than a position of one or more troughs within the channel state information; and determining a reboot event has occurred based on a shift of the one or more troughs within the channel state information.

In one aspect, a non-transitory computer-readable storage medium includes computer-readable instructions, which when executed by a computer, cause the computer to, for each subcarrier within a signal received by multiple access point devices in connection with a station device, determine a measurement of channel state information including an overall shape of the signal; determine a magnitude distance for each subcarrier, wherein the magnitude distance is a total length of a magnitude curve for all subcarriers; and determine a location of the station device based on a fit of the magnitude distance to a model, wherein the model is based on an environment with one or more obstacles causing an obscuration of the signal.

In another aspect, execution of the computer-readable instructions further cause the computer to position the multiple access point devices on a floor map, wherein a location for each AP device is known and recorded, wherein each access point device receives one or more frames from other access point devices within the multiple access point devices; determine the magnitude distance from the one or more frames; and construct a fingerprinting model by recording the magnitude distance, wherein the magnitude distance is correlated with an environment represented by the floor map.

In another aspect, the execution of the computer-readable instructions further cause the computer to inject the signal into a learning model that determines, for each AP device with a known location, which combination of received signal strength indicators and magnitude distances were recorded as the station device moved locations within a floor map; determine that one or more troughs within the signal correspond to loss of signal strength from an obscuring object within the floor map; and construct a prediction of a location of the station device at another environment based on how the magnitude distances and the received signal strength indicators change with changing station device locations.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Example Embodiment

Indoor localization for Wi-Fi devices can rely on a variety of techniques, the main two being signal-strength based and time of flight (ToF) based techniques. ToF requires joint protocol support (and often cooperation) between the AP (Access Point) device(s) and the STA device (Station-client device), and thus is impractical in many scenarios (e.g. IoT (Internet of Things) asset tracking). Signal strength (RSSI—Received Signal Strength Indicator) based techniques are by comparison simpler but suffer from notoriously poor accuracy.

For example, when evaluating a distance based on the STA RSSI, the AP device leverages some variation of the FSPL (Free-Space Path Loss) equation, where the AP device observes the RSSI, and the estimated distance is a log monotonic estimate based on: the STA device transmit power, its antenna transmit gain, the AP device antenna receive gain, and the transmission frequency. Three of the six variables (STA device power, antenna gain, and distance) are unknown, causing the accuracy of the estimation to become highly dependent on guesstimation models. Moreover, in indoor environments, obstacles and multipath may also make the observed variable (Rx RSSI) higher (e.g., multipath) or much lower (e.g., multipath and/or obstacles) than it would be in a strict, obstacle-free environment. In the traditional RSSI-based approach, the ranging accuracy is therefore often said to reach 10-12 meters (90% CDF (Channel Quality measurement)), with a resulting location accuracy of 7 to 10 meters (after trilateration).

RSSI techniques can increase accuracy by also leveraging the Channel State Information (CSI) for the position or range estimation. As the CSI provides information on each individual tone (such as amplitude and angle), the material available to the observer changes from a single aggregate RSSI value, to one RSSI value per receive radio chain, and one CSI per tone and radio chain. As a result, potentially 3400 data points can be measured per received frame (212 CSIs, each with one magnitude and one angle, times 8 antennas, and 8 RSSI values).

Models based on the CSI magnitude by itself, however, are commonly left aside from other localization techniques, because the receive circuit normalizes the magnitude input (thus resulting in measuring the same amplitude at 5 meters and at 50 meters, for example). For example, for a 20 MHz LoS capture at 21 meters and 8 meters, the CSI max amplitude is the same, about ˜45 (e.g., on a scale of 0-255). This means that CSI amplitude cannot be correlated with distance.

Thus, most models relying on CSI leverage the angle at which the signal arrives at a receiver relative to a reference direction. These Angle of Arrival (AoA) techniques compare the angle on multiple AP devices to find the STA device direction (and thus position after triangulation). However, these models are complex to implement in the real world, because they rely on knowledge of the AP orientation, which is widely error-prone. This limitation has drastically limited the adoption of AoA-based solutions.

What is needed are techniques that can use signal strength location, with augmented accuracy compared to a standard RSSI model that provides quick, low complexity location abilities while assuming no particular orientation information from the AP.

Aspects of the present disclosure are directed to using signal strength for location (as many STA devices will not implement ToF and feedback techniques), but also augmenting accuracy compared to a RSSI model, while assuming no particular orientation information from the AP device. The following methods and systems can leverage a magnitude distance-based localization technique that includes, for each subcarrier within the signal received by multiple access point (AP) devices in connection with a station (STA) device, determining a measurement of channel state information (CSI). The CSI measurement can include an overall shape of the signal, such as one or more troughs and peaks related to different obstacles (walls, floors, and furniture, reflections off large surfaces such as glass or metal, etc.) within the path(s) of the signal. A magnitude distance (MD) for each subcarrier can be determined based on the shape of the signal within the CSI measurement, where the magnitude distance is a total length of a magnitude curve for all subcarriers. The location of the STA device can then be determined based on a fit of the MD to one or more models which augment the RSSI. The model(s) can be based on the environment (or similar environment) with one or more obstacles causing an obscuration of the signal.

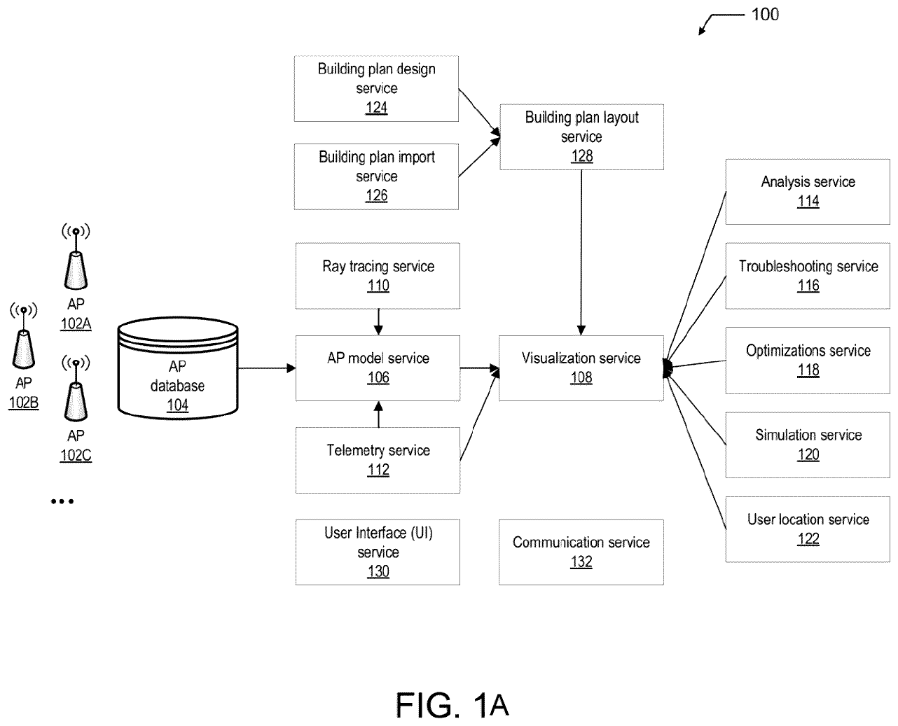

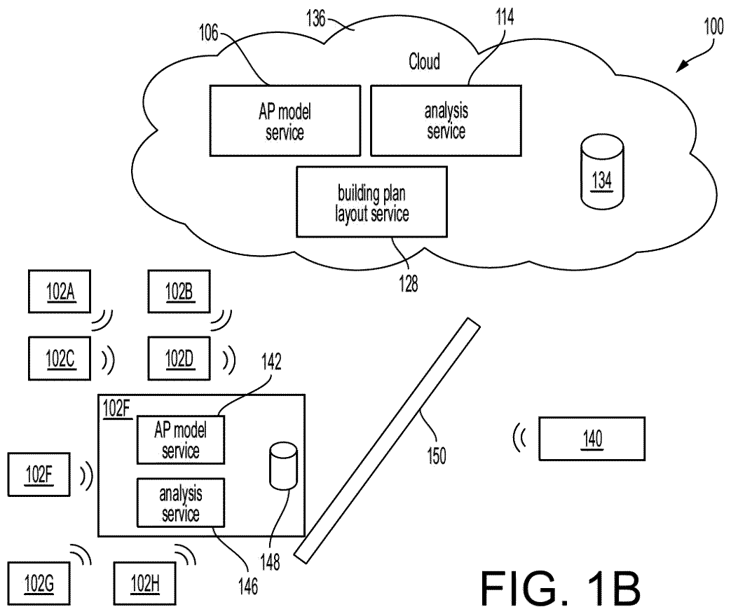

FIG. 1A illustrates an example 3-D signal propagation visualization system 100 for presenting a wireless signal propagation in 3-D according to some aspects of the disclosed technology. As shown in FIG. 1A, the 3-D signal propagation visualization system 100 can include one or more services primarily responsible for examining and analyzing signals from a plurality of access point devices (APs) such as AP 102A, AP 102B, AP 102C, AP 102D, AP 102F, AP 102G, and AP 102H (collectively, APs 102), determining a signal propagation pattern for the APs 102 based on a signal propagation model, and providing a 3-D visualization of the signal propagation pattern including analysis, troubleshooting, simulations, or optimizations of the signal propagation pattern.

The 3-D signal propagation visualization system 100 can include an AP database 104 that includes information about the APs 102, which are configured to transmit AP signals. In some aspects, the information about the APs 102 can include, but is not limited to a location of APs 102 and their orientation (e.g., azimuth and elevation angles), a model number, a signal strength, end-of-life data, an antenna type, or network information of which the APs 102 belong.

The 3-D signal propagation visualization system 100 can include an AP model service 106 that is a collection of signal propagation models for different type of APs 102. In some examples, the signal propagation model includes a description of the signal propagation pattern based on the information associated with the APs 102. For example, such information can be provided by the AP database 104 or related to parameters derived from various measurements such as transmission power (txPower), signal-to-noise ratio (SNR), Key Performance Indicator (KPI) values, or Received Signal Strength Indication (RSSI) values.

The 3-D signal propagation visualization system 100 can include a visualization service 108 configured to perform 3-D modeling, i.e., display a 3-D visualization of the signal propagation pattern based on the signal propagation model. In some examples, the visualization service 108 can display the 3-D visualization of the signal propagation in the form of a heatmap, which uses color-coding to represent different values of the signal strength. In some instances, the visualization service 108 can generate a time-based (temporal) visualization where changes in the signal propagation pattern over time can be presented in the 3-D visualization.

The 3-D signal propagation visualization system 100 can also include a ray tracing service 110 configured to perform ray tracing from a particular AP. In some examples, the ray tracing service 110 can compute attenuation based on the line-of-sight from a particular AP to a certain vertex in space. For example, ray tracing can be used to visualize the signal propagation by tracing paths of light and simulating the way that the light interacts with any objects it may hit. If a straight line is drawn from a particular AP and does not hit anything in the space, then the signal propagation model works in a straightforward manner. On the other hand, if there is an obstacle (e.g., a wall, shelving, ceiling, etc.) along the path, the signal propagation pattern can be broken into multiple segments since the signal propagation pattern can change depending on the properties of the obstacle that the pattern has to pass through.

The 3-D signal propagation visualization system 100 can include a telemetry service 112 configured to collect and record data from the APs 102 or sensors on the floor pertaining to the APs 102 in space. In some examples, the telemetry data can be used to update information about a particular AP (e.g., model, antenna type, etc.) or feed into the visualization service 108 to provide an optimized 3-D visualization instead of relying on a predicted model. In some instances, the telemetry service 112 can utilize the telemetry data to validate a certain predicted model.

The 3-D signal propagation visualization system 100 can also include an analysis service 114 that is configured to analyze data associated with the signal propagation pattern such as SNR measurements, latency measurements, a number of client devices at each of the APs, KPI values, txPower measurements, or RSSI measurements. In some instances, the analysis service 114 can further perform analysis pertaining to data associated with one or more errors or constraints of the APs 102 that can impact the signal propagation pattern.

The 3-D signal propagation visualization system 100 can include a troubleshooting service 116 configured to perform various types of troubleshooting by tracing issues or errors relating to the network performance and signal propagation pattern based on the APs 102 and providing suggestions to resolve such issues or errors. In some examples, the troubleshooting service 116 can identify both cause and consequences of the issues, for example, obstructions in the line of sight, a level of signal coverage, a number of client devices connected to APs, co-channel interference, or stickiness to APs.

The 3-D signal propagation visualization system 100 can include an optimization service 118 configured to provide an optimized 3-D visualization of the signal propagation pattern that provides better operational signal coverage and low interference. In some examples, the optimization service 118 can provide an upgrade option for the APs or configuration settings to achieve improved network performance. In some instances, the optimization service 118 can provide the optimized 3-D visualization that illustrates dynamic changes as conditions in the network change. In some examples, the optimization service 118 can propose different optimized layouts by radio spectrum (RF) or deployment of the APs for a given space.

The 3-D signal propagation visualization system 100 can also include a simulation service 120 configured to simulate various scenarios relating to a deployment of APs, potential network failures, estimated RF leakage, or alternative network configurations. In some instances, the simulation service 120 can provide a simulated 3-D visualization of the various proposed layouts provided by the optimization service 118.

In some examples, the simulation service 120 can provide a simulated 3-D visualization illustrating the impact of an alternative deployment of APs, for example, how the signal propagation pattern is impacted by deploying a new or upgraded AP at different locations on the floor. Also, the simulation service 120 can simulate a 3-D visualization based on the impact of an upgrade or different AP upgrade strategies prior to the actual update to observe and compare the signal propagation pattern.

Furthermore, a type of materials of obstructions in the space can significantly impact the signal propagation pattern. The simulation service 120 can provide a simulated visualization of the signal propagation pattern depending on the type of materials of obstacles such as walls or shelving, or what is stored on shelving (e.g., liquid, metal, non-metal, etc.).

Additionally, the simulation service 120 can provide a simulated 3-D visualization illustrating potential network failures. For example, the simulation service 120 can help define coverage zones to avoid coverage blackout zones in common.

The 3-D signal propagation visualization system 100 can also include a user location service 122 configured to identify a location of a user (e.g., client device) and obtain data associated with the user/client device to determine the signal propagation pattern. For example, a client density can significantly affect the signal propagation pattern.

In some examples, the user location identified by the user location service 122 can be combined with an AP coverage so that the 3-D visualization can include the impact of the client device such as an operating system of client devices, client device density, or any RF interference due to the presence of RF-emitting device (e.g., mobile phones, cordless phones, wireless security cameras, etc.).

In some examples, the user location service 122 can help to optimize the latency and the signal propagation pattern by identifying the location of client devices and the type of services that the client devices are performing. For example, too many client devices performing VoIP calls on the same AP can worsen the network performance and cause a bad call quality due to latencies. The 3-D visualization of the signal propagation pattern can include the user location provided by the user location service 122 to illustrate such impact of the client devices on the signal propagation pattern.

The 3-D signal propagation visualization system 100 can also include a building plan design service 124 configured to allow a user to manage the settings of the building plan or the floor plan of the space (e.g., layout, objects, viewpoint, etc.).

The 3-D signal propagation visualization system 100 can include a building plan import service 126 configured to import a building plan or a floor plan. The building plan or the floor plan can be in any suitable format, for example, a Building Information Modeling (BIM) file or a Computer-Aided Design (CAD) file. In some examples, the building plan import service 126 can import the building plan or the floor plan that contains a technical drawing, blueprint, schematic, or 3-D rendering of the floor that is to be visualized in 3-D.

In some instances, the signal propagation pattern can be overlaid over the building plan or the floor plan provided by the building plan import service 126. Depending on the type of the imported file for the building plan, details of the building or the floor such as a type of materials of the obstacles (e.g., a wall, etc.) or location of APs or sensors can further be included in the building plan.

The 3-D signal propagation visualization system 100 can also include a building plan layout service 128 configured to store the building plan layout and support the 3-D visualization of the building plan layout. In some examples, the building plan layout service 128 can perform the function of a management and control platform for managing, monitoring, and storing data associated with the visualization based on the building plan.

The 3-D signal propagation visualization system 100 can also include a user interface service 130 configured to allow a user to manage and control settings of the visualization or network configurations to optimize the 3-D visualization. For example, the settings can include a viewpoint (e.g., a first-person perspective, an orbit view, or a bird's eye view), layout, parameters (e.g., txPower, SNR measurements, KPI values, RSSI values, etc.), or visualization options. Also, the examples of network configurations can include but are not limited to elevation or azimuth angle of APs, deployment of APs, and a type of network or APs.

In some instances, the user interface service 130 can provide information to or receive feedback from the user via a communication service 132 as further described below. In some examples, the user may be asked to evaluate and manage various suggestions proposed by the troubleshooting service 116 or the optimization service 118.

The 3-D signal propagation visualization system 100 can also include a communication service 132 configured to transmit and receive information wirelessly over a network. In some examples, the communication service 132 can send and receive communications from/to a building plan system (not shown) that may provide building plan updates. In some instances, the communication service 132 can transmit and receive data from/to a user for analyzing, troubleshooting, simulating, or optimizing the 3-D visualization of the signal propagation pattern.

FIG. 1B illustrates an example system using the 3-D signal propagation visualization system 100 for an RSSI-based range accuracy augmentation in accordance with an example embodiment. In 3-D signal propagation visualization system 100, a station (STA) device (e.g., client device) such as STA device 140 is in connection with multiple access point (AP) devices 102A-H. The STA device 140 is the device whose location is to be determined, and can be any client device capable of transmitting a signal, including a wireless communication device, a radio transmitter, a Bluetooth transmitter, etc. In 3-D signal propagation visualization system 100, while just one STA device 140 is shown, any number of client devices are contemplated by the magnitude distance techniques described. AP devices 102A-H are configured to receive the signal transmitted from the STA device 140. Each AP device 102A-H includes a radio chain including at least an antenna and a signal receiver configured to convert the received signal into a measurable form. In 3-D signal propagation visualization system 100, 4-8 AP devices 102A-H are shown, although any number of AP devices are contemplated by the magnitude distance techniques described. The environment of 3-D signal propagation visualization system 100 includes one or more obstacles, multipath effects, and interference that can impact RSSI accuracy. In 3-D signal propagation visualization system 100, wall 150 is an obstacle that can reduce and/or distort the signal strength and can lead to significant variations in RSSI.

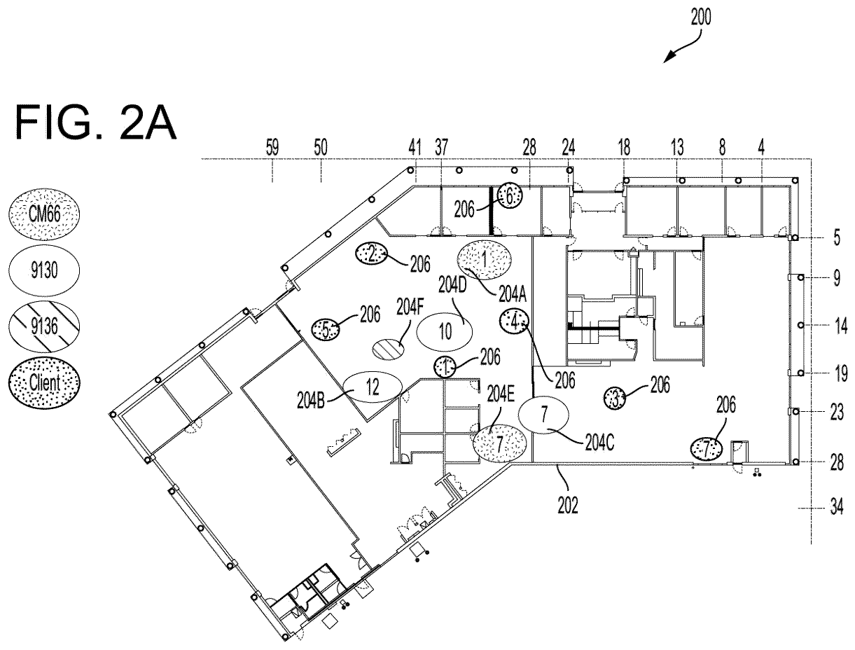

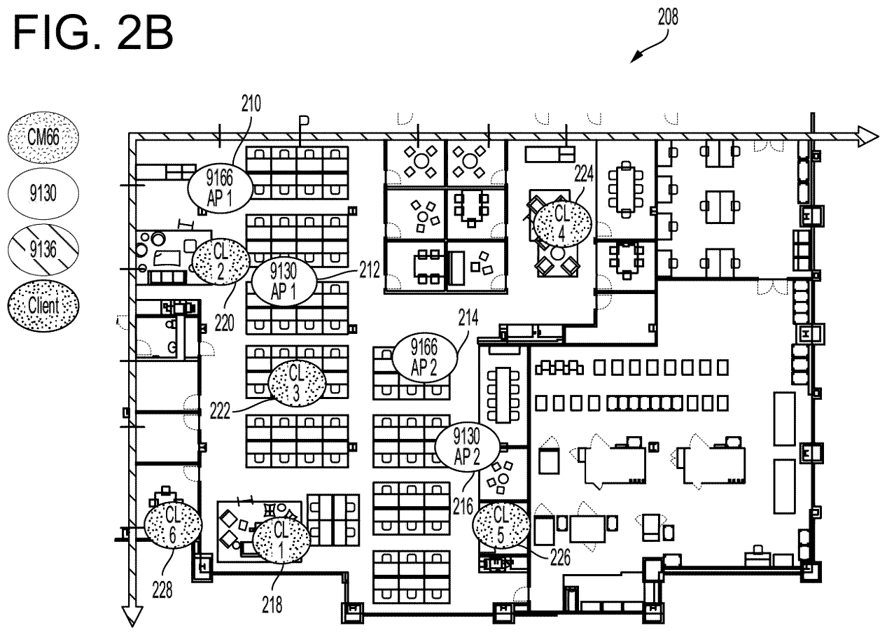

FIG. 2A, for example, shows an example environment 200 in which the components of FIGS. 1A and 1B can be implemented. The environment 200 encompasses a building 202 with multiple AP devices positioned on the floor map. In this example, AP device 204A, AP device 204B, AP device 204C, AP device 204D, AP device 204E, and AP device 204F (collectively, AP devices 204A-F) are the AP devices 102A-H, where each location of the AP device is known and recorded. In some embodiments, the locations of AP devices 204A-F can be stored within AP store 148 shown in FIG. 1B. Each AP device of AP devices 202A-F can receive one or more frames from the other AP devices within the environment 200 (e.g., AP device 204A can receive frames from AP device 202B-F, and so on). The STA device 140 is shown as client device 206, which can be in one of the 7 places shown within environment 200.

In FIGS. 2A and 2B, CM 66, 9130, 9136, and/or 9166 refer to generic building/rooms numbers and locations that are non-limiting and exemplary only.

FIG. 2B shows another example environment 208, which includes multiple STA/client devices operating with the disclosed techniques. Specifically, environment 208 includes AP devices 210, 212, 214, 216 and client devices 218, 220, 222, 224, 226, and 228. Each of the client devices can leverage the AP devices for enhanced RSSI localization. Multiple obstacles such as walls, furniture, and different types of surfaces are shown within environment 208.

Environments 200, 208 illustrate how indoor localization faces a challenging radio propagation environment, including multipath effect, shadowing, fading and delay distortion as a result of obstacles affecting the signal from client device 206. Obstacles, for example, can be walls, floors, furniture, reflections off large surfaces such as glass or metal, etc.) within the path(s) of the signal from client device 206 to any of AP device(s) 204A-F. For example, while the path of the signal may be unimpeded between client device 206 and AP device 204C at position 1, multiple walls are between client device 206 and AP device 204E at position 1. In the latter case, many effects may affect the CSI data, such as a multipath effect, where the signal arrives at the AP device 204E via multiple paths due to reflections, diffractions, and scattering caused by the obstacles in the room (e.g., the walls). This results in several copies of the same signal reaching the AP device 204E at different times and from different directions. Shadowing can also occur based on variations in signal strength caused by obstacles or obstructions in the environment that partially block or attenuate the signal. These obstacles can create areas of reduced signal strength, known as “shadowed” regions, where the signal is weaker than it would be in an unobstructed area. Fading refers to the variations in signal strength that occur as a signal travels through a wireless medium. This phenomenon is primarily due to the interaction of the signal with various environmental factors (for example, Rayleigh Fading, Rician Fading, Log-Normal Fading, Doppler Shift, etc.). Delay distortion, often referred to as dispersion in the context of signal transmission, affects RSSI by causing variations in the signal's arrival time at the receiver. This phenomenon is particularly relevant in systems where multiple signals or signal components arrive at slightly different times due to their travel paths through different mediums.

The space of leveraging CSI to improve on RSSI-measurements affected by, potentially, multipath effect, shadowing, fading and/or delay distortion can be divided into two main schemes, (1) Fingerprint-based schemes and (2) Magic-box-based schemes. However, each scheme has considerable drawbacks.

Referring back to FIG. 1B, for Fingerprint-based schemes, a first offline phase collects samples from a known set of locations, and records the STA device 140 associated parameters (RSSI, CSI magnitude, and phase). Then, an online phase positions the STA device 140 at one of the previously surveyed positions, and the location engine attempts to find the most likely location by comparing the newly collected parameters to those recorded during the offline training phase. However, these models are highly dependent on fingerprinting. RSSI Fingerprinting involves creating a detailed map of signal strengths at various locations within an area and then using this map to estimate the STA's 140 position. This means that each square of a grid of a venue's environment must be sampled in any new venue. RSSI Fingerprinting by itself does not work in new environments, and does not work as soon as any change is made to the known environment (e.g., furniture change or other). By contrast, augmenting RSSI Fingerprinting with the magnitude distance adapts to local changes, does not use a fingerprinting grid, and thus does not require a systematic offline training phase for all the floor locations.

For Magic-box-based schemes, in order to improve on fingerprinting limitations, other methods separate the location from the sample collection. This way, CSI and RSSI values are collected for multiple locations (multiple floors, multiple buildings, etc.) in the hope of building a somewhat general model. Then, a series of learning machine engines are inserted to reconcile incompatible RSSI and distance values between buildings and provide a somewhat accurate range prediction on the trained dataset. However, despite their aspiration to generality, these models do not scale to many different environments (because of conflicting RSSI/CSI angles and distance values in different environments-in the above art for example, a new model is built for any new building). Magic-box-based schemes also result in very large models when different building samples are clubbed together (thus are difficult to use in the real world).

Most of the above techniques also rely on the CSI phase (not the magnitude), because according to these techniques, the magnitude is normalized. Thus, the CSI magnitude is left unused except when it is thrown with anything else into the magic-box (but results cannot be explained or correlated). By contrast, the following magnitude distance technique uses the CSI amplitude, and provides an explainable result. In other words, the user can know what the contribution of the CSI magnitude was to the range accuracy.

The magnitude distance technique increases the accuracy and usability of RSSI-based location in different and new environments by augmenting it with CSI magnitude data. It provides a model general enough that fingerprinting is not needed for every tracked location. The exact AP orientation is also not needed (thus the CSI phase is not leveraged). It uses a learning machine, but with a restricted set of features so that predictions can be explained (e.g., no magic box).

In some embodiments, the CSI magnitude data is collected and analyzed on premise. For example, AP 102F can be an access point that incorporates an Rx radio chain as part of its overall functionality. The Rx radio chain within the AP 102F receives and processes incoming wireless signals from STA device 140 The components of this chain, including the antenna, LNA, mixer, IF filter, ADC, DSP, and baseband processor, work together to ensure that the signals received by the AP 102F are accurately converted into usable data.

The AP 102F can include an analysis service 146 that analyzes RSSI and CSI data from the STA device 140 upstream frames. For example, 4 or 8 radio chains (e.g., within AP devices 102A-H) can receive the STA device 140 frame, measure individual chain RSSI, and also collect 53 to 212 tones per chain (depending on the STA BW), each with a phase and magnitude. The analysis service 146 can determine the peak/trough structure within the magnitude data, which can depend on the obstacle(s) (e.g., wall 150) between the AP 102F and the STA device 140. The analysis service 146 constructs, for each receive chain, the total length of the magnitude curve for all tones. The length, called the magnitude distance (MD), is stored along with the RSSI for that Rx radio chain in AP store 148.

One or more models within the AP model service 142 determines which distance is most likely to surface such combination for each approaching set of values. The AP model service 142 then surfaces the distance of the STA device 140 to each detecting AP 102A-H, which can then be used to augment any trilateration or other location determination method. In some embodiments, the models of the environment can be stored throughout time in AP store 148. Additionally, and/or alternatively, models based on similar environments can be stored within AP store 148 for easy access by AP model service 142.

A location of the STA device 140 can be determined by the analysis service 146 based on a fit of the magnitude distance to a model within the AP model service 142, where the model is based on the environment (or a similar environment) with the obstacles causing an obscuration of the signal within the magnitude data. The location can be determined in this way for a single STA device moving within multiple areas, such as client device 206 in one of the 7 places shown within environment 200, or for multiple STA devices, such as the client devices 218, 220, 222, 224, 226, and 228 in environment 208.

In some embodiments, the CSI magnitude data can be analyzed in cloud 136 instead of on premise. In this case, the AP model service 106 and analysis service 114 can be on cloud 136, with models based on similar environments that can be stored within cloud store 134 for easy access by AP model service 106. Building plan layout service 128 can include the different types of environments, such as office building environments, outdoor environments, underground environments such as subway or public transit environments, etc.

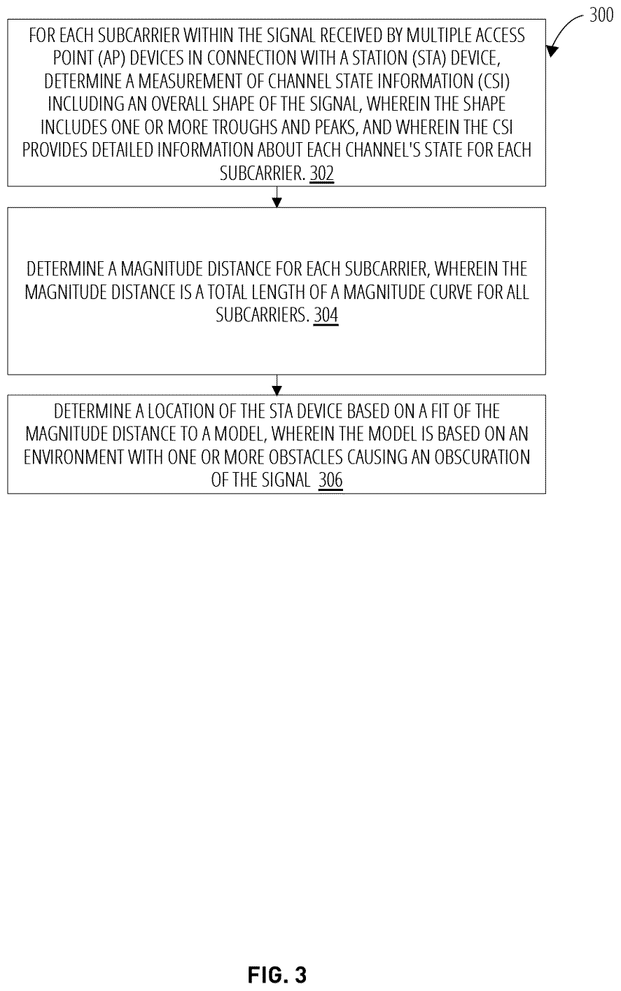

FIG. 3 illustrates a routine 300 for RSSI-based range accuracy augmentation in accordance with an example embodiment. This method improves RSSI-based location by augmenting it with CSI magnitude data. Routine 300 provides a model general enough that fingerprinting is not needed for every tracked location. The exact AP orientation is also not needed (thus the CSI phase is not leveraged). Routine 300 uses a learning machine, but with a restricted set of features so that predictions can be explained (e.g., no magic box).

First, in block 302, RSSI and CSI data is collected from the STA device upstream frames. A measurement of the CSI magnitude is collected for each subcarrier within a signal received by multiple access point (AP) devices in connection with the STA device. As an example, in 3-D signal propagation visualization system 100 in FIG. 1B, 4-8 radio chains can receive the STA frame, measure individual chain RSSI, and also collect 53 to 212 tones per chain (depending on the STA BW), each with a phase and magnitude.

In some embodiments, the phase value may be used to determine the signal Angle of Arrival (AoA), which can be leveraged to establish the relative orientation of the STA to the AP when the AP orientation is known. This method, however, leaves the phase value optional. Routine 300 can be implemented free from the requirement that forces the knowledge of the AP orientation, and thus does not need to leverage the phase data.

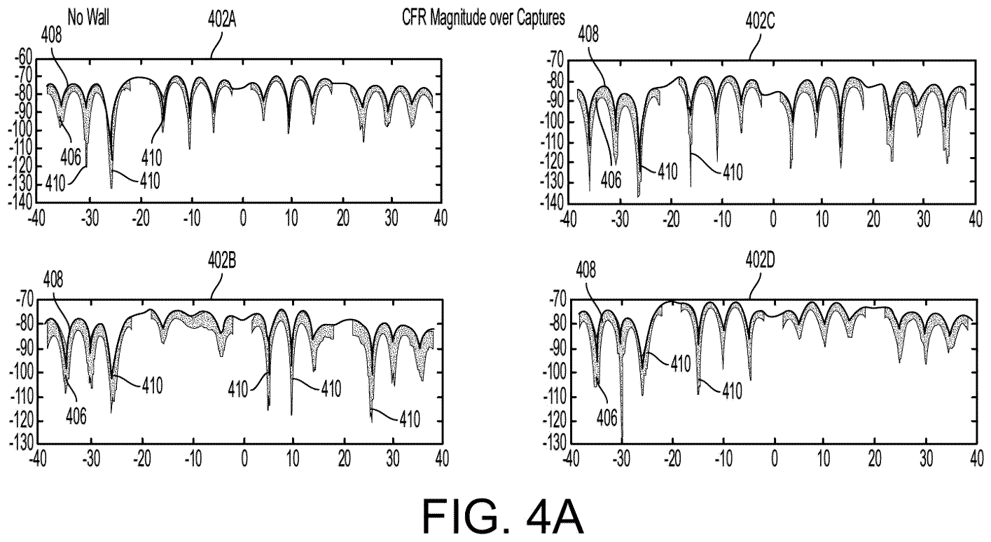

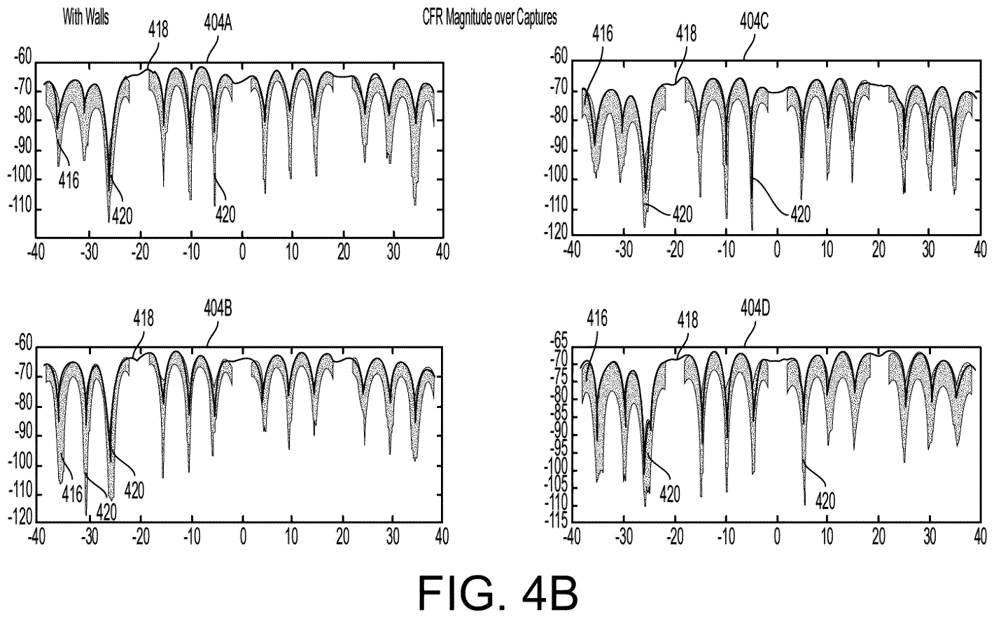

FIG. 4A and FIG. 4B show examples of magnitude curves 402A, 402B, 402C, 402D, 404A, 404B, 404C, and 404D. In each magnitude curve, the CSI magnitude data 406 and the CSI magnitude data 416 is collected for each subcarrier within 3-D signal propagation visualization system 100. The CSI magnitude data 406 and the CSI magnitude data 416 can include an overall shape of the signal, such as one or more troughs and peaks. The CSI magnitude data 406 and the CSI magnitude data 416 can additionally provide detailed information about each channel's state for each subcarrier, including the amplitude and phase shift.

FIG. 4A, for example, shows CSI magnitude data 406 for an environment with no walls in accordance with an example embodiment. In these data sets, for each subcarrier, only minor obstructions are present, such as furniture. Subcarriers, for example, can be the individual frequency channels that make up the overall bandwidth. Each subcarrier transmits a part of the data, and 3-D signal propagation visualization system 100 (e.g., analysis service 146 and/or analysis service 114) can analyze each subcarrier's strength and phase to understand the channel's state. In some embodiments, tones and subcarriers can be used interchangeably.

The CSI magnitude data 406 includes many peaks and troughs 410. The magnitude curve 402A, for example, shows the CSI magnitude data 406 over 8 radio chains and 212 individual tones. It is clear that the magnitude peak is about the same for one chain to the next. A different shape, but same magnitude peak levels, would be seen for another STA device 140 positioned at another distance (thus the magnitude itself is not reflective of the distance). The troughs 410 form the “shape” the CSI magnitude data 406 takes based on its environment—in this case, an environment with no walls.

However, the ability of the Rx circuitry to react to changes to the Rx signal intensity, due to multipath, depends on the signal mean intensity, thus on distance to the STA device 140, but also the structure of the environment between the AP 102F and the STA device 140. Changes due to multipath will translate differently whether there is line of sight or a wall between the STA device 140 and the AP 102F. These differences translate in a different peak/trough structure depending on the obstacle between the AP 102F and the STA device 140.

FIG. 4B shows example CSI magnitude data 416 for a different environment with different obstacles—for example, an environment with walls. With the addition of walls, the peaks and/or troughs 420 become much more pronounced. A different “shape” of the CSI magnitude data 416 is produced from that of CSI magnitude data 406.

For example, when the STA device 140 is far, the mean amount of energy received is low, and multipath changes causes peaks and troughs that are larger (in percentage, comparatively to the signal received) to those observed when the STA device 140 is closer (and the mean signal stronger). The same phenomenon can be observed if the STA device 140 is close, but separated from the AP 102F by a thick wall. However, in that case the peaks and troughs caused by multi path (behind the wall) are dampened (by the wall) and shorter (than in LoS). However, the peaks and troughs caused by multipath in front of the wall are sharper (than in LoS). It is therefore possible to observe an RSSI value, the associated CSI magnitude structure, and deduce the likelihood of a wall presence, and its associated thickness (degradation of the RSSI) based on the shape of the magnitude data.

The shape of the magnitude data can be quantified as a magnitude distance (MD). The MD is shown as MD 408 in FIG. 4A and MD 418 in FIG. 4B. For example, the following techniques construct, for each receive chain, the total length of the magnitude curve for all tones. In block 304, routine 300 determines a magnitude distance for each subcarrier, where the magnitude distance is a total length of a magnitude curve for all subcarriers. The length (e.g., MD), is stored along with the RSSI for that Rx radio chain. A strong advantage of such a method is that in some embodiments it only stores 3 values per Rx chain (chain ID, RSSI and MD), and is thus much lighter than other methods (current RSSI techniques store up to 212 angle values per chain).

In block 306, routine 300 determines a location of the STA device based on a fit of the magnitude distance to a model. The model can be based on an environment with one or more obstacles causing an obscuration of the signal. In some embodiments, a fingerprinting model can be constructed by recording the MD, where the MD is then correlated with an environment and its obstacles represented by the floor map. The floor map can be stored in AP store 148 and/or cloud store 134, which can be accessed by AP model service 142 on AP 102F and/or AP model service 106 within cloud 136. That way, once the MD is determined from one or more frames at the same or similar environment, the location of the STA device 140 can be accurately determined.

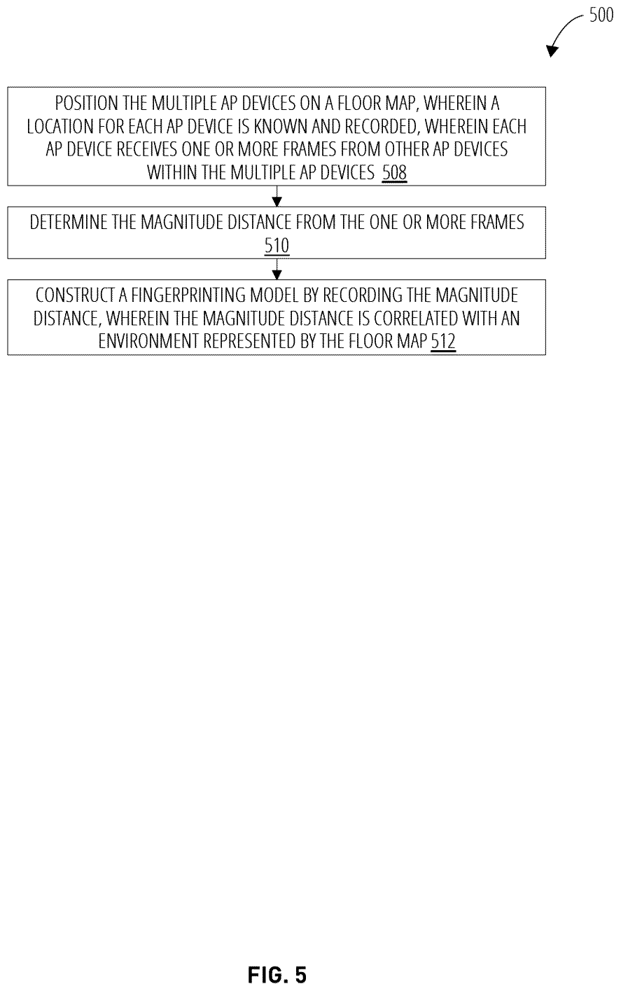

For example, routine 500 of FIG. 5 shows a method for generating fingerprinting models based on the MD in accordance with an example embodiment. In block 508, routine 500 positions the multiple AP devices on a floor map, where a location for each AP device is known and recorded. For example, in FIG. 2B, AP devices 210, 212, 214, 216 are deployed in environment 208. AP devices 210, 212, 214, 216 can also be positioned on a floor map (thus AP positions and relative distances are recorded and known, which is a given for STA location tracking).

Each AP device can receive one or more frames from the other AP devices within environment 208. For example, AP device 214 can receive some frames (beacons, NDP messages, etc.) from AP devices 210, 212, and/or 216. With this method, these frames are recorded and form a training set. In block 510, routine 500 determines the MD from the one or more frames within the training set. Then, for each AP and radio chain, the Rx RSSI and associated MD are recorded. The known distance to the AP device is also stored (e.g., the known distance to AP device 214 is stored within AP store 148 and/or cloud store 134. This training set forms a fingerprinting database equivalent, but without the need to test floor individual locations.

Once a sufficient number of frames are received and recorded (any number of frames is contemplated and the exact quantity is configurable, but for simplicity assume that 3-D signal propagation visualization system 100 starts converging after about one hundred frames per pair [leveraging beacons, this represents 10 seconds]; larger sets result in improved predictions), the dataset is injected into a learning algorithm. The learning algorithm can be included in AP model service 142 (on premise embodiments) and/or AP model service 106 (cloud embodiments) that construct one or more models that augment RSSI location based on MD determinations. For example, the learning algorithm task is to determine, for each recorded distance, which combination of RSSIs and MDs were recorded, and thus infer how RSSIs and MDs would differ as the distances would change. In block 512 then, routine 500 constructs a fingerprinting model by recording the MD in AP store 148 and/or cloud store 134, where the magnitude distance is correlated with an environment represented by the floor map within analysis service 146 and/or analysis service 114.

This learning algorithm is then leveraged to predict the distance of STAs to each detecting AP, when STA devices are then introduced in the environment 200, 208. The RSSI alone would be insufficient as explained before. For example, the models determine that one or more troughs within the signal correspond to loss of signal strength from an obscuring object within the floor map, which can be measured based on the MD. The signal can be injected into a learning model that determines, for each AP device with a known location, which combination of Received Signal Strength Indicators (RSSIs) and MDs were recorded as the STA device moved locations within the floor map.

For example, in some embodiments the trained engine performs a tree search based on the received RSSI and MD for that STA frame, and determines which distance is most likely to surface such combination for each approaching set of values. The algorithm them performs a Random-forest-like vote to determine which distance is most likely. Gradient booster (e.g. XGBoost) regressors and classifiers, for example, can obtain good performances for this task, but it should be clear that any other similar process could be used to similar effects. Such method is efficient, because signal degradation is log-linear in a given environment (e.g. in LoS), but has a different starting point depending on the environment (e.g. LoS vs. a STA behind a wall). Thus, the tree exploration structure allows the method to explore possibilities until the most likely log-linear segment is found from where distance is estimated. 10. The system surfaces the distance of the STA to each detecting AP, which can then be used for trilateration or other location determination method. Therefore, a distance of the STA device can be determined using a predictive model based on a combination of the RSSI and the MD.

This method can be utilized for the any similar environments as well. The models can construct a prediction of the STA device 140 location at another environment based on how the magnitude distance and RSSI changes with changing STA device 140 location. Therefore, it is possible to generate a fingerprinting model for the floor map of environment 208 that works for the floor map of environment 200 since they are both office environments, but the same fingerprinting model would not work as well for an underground subway system.

In some embodiments, a packet exchanged between the STA device 140 and the AP devices 102A-H within the environment can include its augmented RSSI information relatively lightly. For example, the packet may include a chain identifier, RSSI, and MD per radio chain. AP 102F can use the chain identifier, RSSI, and/or MD per radio chain to determine the location of any STA device/client device within environment 200, 208.

In some embodiments, transient obstacles that affect RSSI location can be thrown out of the data sets. For example, if a vehicle passes between the line of sight between an AP device (e.g., AP 102F) and STA device 140, then a change within the MD will occur because the AP devices within 3-D signal propagation visualization system 100 continuously receive the signal. The analysis service 146 can, in this instance, detect a change within the MD (threshold value, rate of change) for some period of time. If the analysis service 146 determines that the change within the MD is associated with a moveable obstacle (e.g., a truck), the analysis service 146 can adjust the location determination of the STA device 140 based on that determination. Thus, throwing out outliers allows AP 102F to deal with transient obstacle changes like trucks obscuring the STA device 140 from itself and the other AP devices.

Additionally, and/or alternatively, the analysis service 146 can account for reboot events. For example, since the analysis service 146 can determine a distance of the STA device 140 based on the MD rather than a position of one or more troughs within the CSI, it can determine a reboot event has occurred based on a shift of the one or more troughs within the CSI.

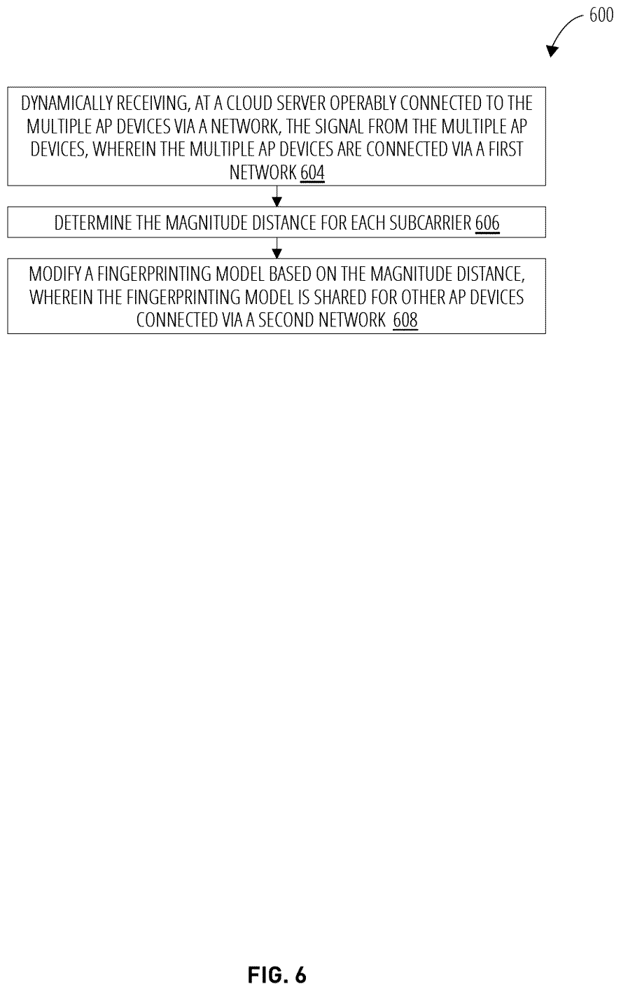

FIG. 6 illustrates a routine for cloud-based fingerprinting models in accordance with an example embodiment. In block 604, routine 600 includes dynamically receiving, at a cloud server operably connected to the multiple AP devices via a network, a signal from the AP devices within an environment. The AP devices can be connected, for example, by a first network. Types of networks can include any public and/or private network, such as WiFi, Local Area Network (LAN), Wide Area Network (WAN), Virtual Private Network (VPN), Intranet, Extranet, Personal Area Network (PAN), etc.

In block 606, routine 600 determines the MD for each subcarrier within cloud 136. For example, each Access Point (AP) can receive one or more frames from other AP devices within the environment 208, which are then sent to analysis service 114 within cloud 136. For instance, AP 102F may receive frames such as beacons or Neighbor Discovery Protocol (NDP) messages from AP devices 102A-E and 102G-H.

In some embodiments, these received frames can be sent to cloud store 134 and recorded in cloud store 134 to create a training set. The analysis service 114 processes these frames to determine the Magnitude Distance (MD) from the training set. For each AP and radio chain, the Received Signal Strength Indicator (Rx RSSI) and the associated MD are recorded within cloud store 134, along with the known distance to the AP device (e.g., the known distance to AP device 214 is stored in cloud store 134). This training set effectively serves as a fingerprinting database, eliminating the need to test individual floor locations.

Once a sufficient number of frames are collected and recorded, the data is fed into a learning algorithm within AP model service 106, which then constructs models that enhance RSSI location estimates based on MD determinations. Specifically, the algorithm determines how RSSIs and MDs vary with distance by analyzing recorded data. A fingerprinting model is built by correlating the MD with the environment represented by the floor map, which is stored in cloud store 134 for use in the same or similar environments encountered by other users of 3-D signal propagation visualization system 100.

In some embodiments, the AP model service 106 performs a tree search based on the received RSSI and MD for the STA device 140 frame to identify the most probable distance. This is followed by a Random Forest-like voting process to predict the most likely distance. Gradient boosting methods, such as XGBoost, can be effective for this task, but other similar algorithms may also be used. The AP model service 106 then calculates the distance of the STA device 140 from each detecting AP, which can be used for trilateration or other location-determination methods. Thus, the distance of the STA device 140 is determined based on a predictive model supplied by AP model service 106 that combines RSSI and MD data.

In block 608, routine 600 modifies a fingerprinting model based on the MD, where the fingerprinting model is shared for other AP devices within another network. For example, other users who subscribe to the cloud 136 can utilize AP model service 106 analysis service 114 based on determining which floor plan is closest, which can be implemented by building plan layout service 128. Other networks that may share cloud 136 can include any public and/or private network, such as WiFi, LAN, WAN, VPN, Intranet, Extranet, PAN, etc.

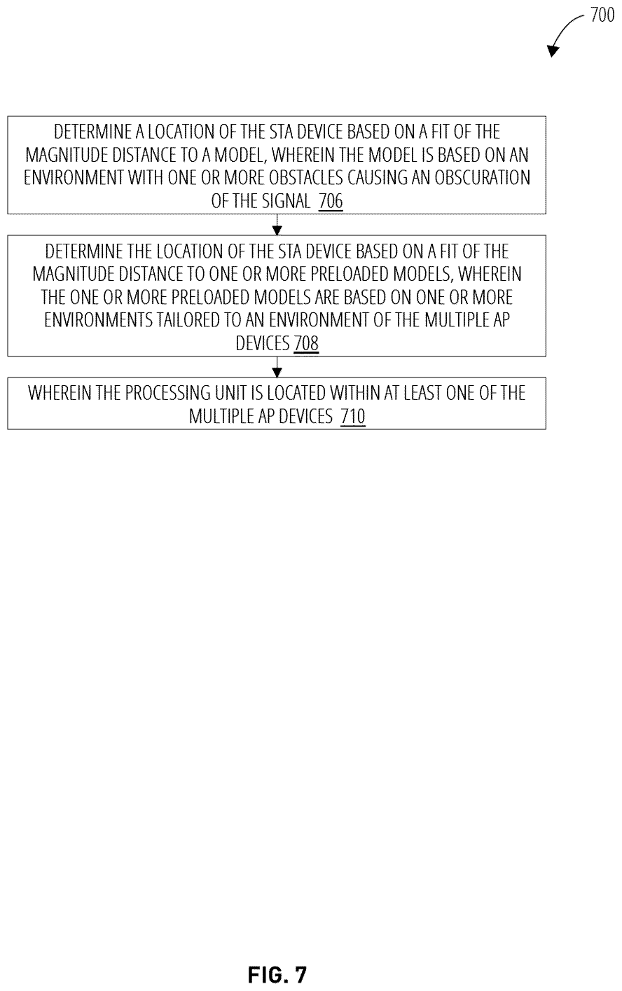

FIG. 7 illustrates a routine for on premise fingerprinting models in accordance with an example embodiment. In this embodiment, all the analysis and processing is done within AP 102F. In block 706, routine 700 determines a location of the STA device 140 based on a fit of the MD to a model(s) within AP model service 142. The model(s) come preloaded with environments the same or similar to the current environment. In some embodiments, the model(s) can come tailored to the environment to save space on the AP 102F.

For example, the analysis service 146 calculates the MD. Specifically, AP 102F can receive frames, such as beacons or Neighbor Discovery Protocol (NDP) messages, from AP devices 102A-E and 102G-H. In block 708, routine 700 determines the location of the STA device 140 based on a fit of the MD to one or more preloaded models stored within AP store 148, where the one or more preloaded models are based on one or more environments tailored to an environment of the multiple AP devices (e.g., environment 200 or environment 208). For example, the AP model service 142 can conduct a tree search based on the received RSSI and MD data from the STA device 140 frame to estimate the most likely distance. This is followed by a Random Forest-like voting process to determine the most probable distance. Gradient boosting techniques, such as XGBoost, are effective for this purpose, though other similar algorithms may also be employed. The AP model service 142 then computes the distance of the STA device 140 from each detecting AP device, which can be utilized for trilateration or other location-determination methods. Consequently, the distance of the STA device 140 is determined using an on premise predictive model provided by AP model service 142 that integrates RSSI and MD data.

In block 710, the processing unit is located within at least one of the multiple AP devices, keeping this technique completely on premise.

Therefore, the disclosed systems, methods, and techniques improve RSSI-based ranging by incorporating CSI magnitude through a magnitude distance (MD) determination, and leveraging the finding that the CSI magnitude can be used to surface the nature of obstacles between the STA device and the AP device. RSSI-based ranging is commonly used in environments where the STA device cooperation is not expected (e.g., non-FTM environments, IoT and other asset tracking), but is made difficult to use because of the inaccuracy of RSSI-to-range conversion. The disclosed systems, methods, and techniques improves this accuracy by a factor of at least about 15, with the mere addition of a light addition—parameter computation (e.g., the MD).

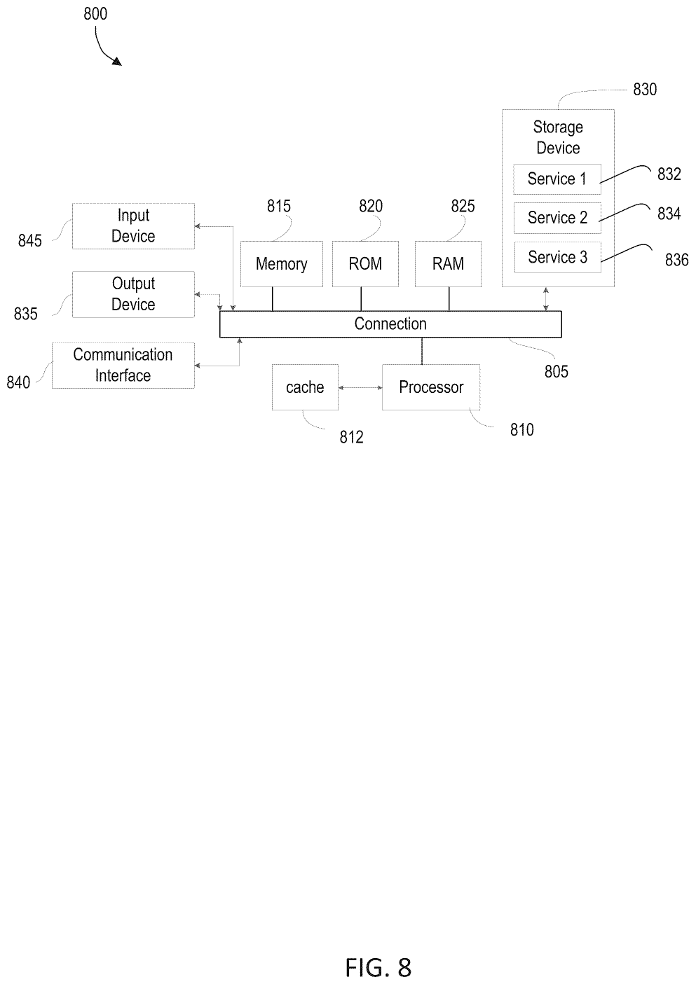

FIG. 8 shows an example of computing system 800, which can be for example any computing device or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments computing system 800 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example computing system 800 includes at least one processing unit (CPU or processor) such as processor 810 and connection 805 that couples various system components including system memory 815, such as read only memory (e.g., ROM 820) and random access memory (e.g., RAM 825) to processor 810. Computing system 800 can include a cache of high-speed memory 812 connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. There is no restriction on operating on any particular hardware arrangement and therefore the basic features here may easily be substituted for improved hardware or firmware arrangements as they are developed.

Storage device 830 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A system comprising:
a station device configured to transmit a signal;
multiple access point devices in connection with the station device, the multiple access point devices configured to receive the signal transmitted from the station device, wherein the multiple access point devices are configured to convert the signal into a measurable form; and
a processing unit operably connected to the multiple access point devices, wherein the processing unit is configured to:
for each subcarrier within the signal received by the multiple access point devices, determine a measurement of channel state information including an overall shape of the signal;
determine a magnitude distance for each subcarrier; and
determine a location of the station device based on a fit of the magnitude distance to a model, wherein the model is based on an environment with one or more obstacles causing an obscuration of the signal.

2. The system of claim 1, wherein,
the multiple access point devices are positioned on a floor map, wherein a location for each access point device is known and recorded;
each access point device receives one or more frames from other access point devices within the multiple access point devices; and
the processing unit is further configured to:
determine the magnitude distance from the one or more frames; and
construct a fingerprinting model by recording the magnitude distance, wherein the magnitude distance is correlated with an environment represented by the floor map.

3. The system of claim 1, wherein the processing unit is further configured to:
inject the signal into a learning model that determines, for each access point device with a known location, which combination of received signal strength indicators and magnitude distances were recorded as the station device moved locations within a floor map;
determine that one or more troughs within the signal correspond to loss of signal strength from an obscuring object within the floor map; and
construct a prediction of a new location of the station device at another environment based on how the magnitude distances and the received signal strength indicators change with changing station device locations.

4. The system of claim 1, wherein the processing unit is further configured to:
apply a tree search based on a received signal strength indicator and the magnitude distance; and
determine a distance of the station device using a predictive model based on a combination of the received signal strength indicator and the magnitude distance.

5. The system of claim 1, wherein the system further comprises:
a cloud server, operably connected to the multiple access point devices via a network, the cloud server being configured to:
dynamically receive the signal from the multiple access point devices, wherein the multiple access point devices are connected via a first network;
determine the magnitude distance for each subcarrier; and
modify a fingerprinting model based on the magnitude distance, wherein the fingerprinting model is shared for other access point devices connected via a second network.

6. The system of claim 1, wherein the processing unit is further configured to:
determine the location of the station device based on a fit of the magnitude distance to one or more preloaded models, wherein the one or more preloaded models are based on one or more environments tailored to an environment of the multiple access point devices; and
wherein the processing unit is located within at least one of the multiple access point devices.

7. The system of claim 1, wherein a packet exchanged between the station device and the multiple access point devices includes a chain identifier, a received signal strength indication, and a magnitude distance per radio chain.

8. The system of claim 1, wherein the multiple access point devices are configured to continuously receive the signal and the processing unit is further configured to:
detect a change within the magnitude distance for a period of time;
determine the change within the magnitude distance is associated with a moveable obstacle to yield a determination; and
adjust the location determined for the station device based on the determination.

9. The system of claim 1, wherein the processing unit is further configured to:
determine a distance of the station device based on the magnitude distance rather than a position of one or more troughs within the channel state information; and
determine a reboot event has occurred based on a shift of the one or more troughs within the channel state information.

10. A method comprising:
for each subcarrier within a signal received by multiple access point devices in connection with a station device, determining a measurement of channel state information including an overall shape of the signal;
determining a magnitude distance for each subcarrier, wherein the magnitude distance is a total length of a magnitude curve for all subcarriers; and
determining a location of the station device based on a fit of the magnitude distance to a model, wherein the model is based on an environment with one or more obstacles causing an obscuration of the signal.

11. The method of claim 10, further comprising:
positioning the multiple access point devices on a floor map, wherein a location for each access point device is known and recorded, and each access point device receives one or more frames from other access point devices within the multiple access point devices;
determining the magnitude distance from the one or more frames; and
constructing a fingerprinting model by recording the magnitude distance, wherein the magnitude distance is correlated with an environment represented by the floor map.

12. The method of claim 10, further comprising:
injecting the signal into a learning model that determines, for each access point device with a known location, which combination of received signal strength indicators and magnitude distances were recorded as the station device moved locations within a floor map;
determining that one or more troughs within the signal correspond to loss of signal strength from an obscuring object within the floor map; and
constructing a prediction of a new location of the station device at another environment based on how the magnitude distances and the received signal strength indicators change with changing station device locations.

13. The method of claim 10, further comprising:
applying a tree search based on receiving a received signal strength indication and the magnitude distance; and
determining a distance of the station device using a predictive model based on a combination of the received signal strength indicator and the magnitude distance.

14. The method of claim 10, further comprising:
dynamically receiving, at a cloud server operably connected to the multiple access point devices via a network, the signal from the multiple access point devices, wherein the multiple access point devices are connected via a first network;
determining the magnitude distance for each subcarrier; and
modifying a fingerprinting model based on the magnitude distance, wherein the fingerprinting model is shared for other access point devices connected via a second network.

15. The method of claim 10, further comprising:
determining the location of the station device based on a fit of the magnitude distance to one or more preloaded models, wherein the one or more preloaded models are based on one or more environments tailored to an environment of the multiple access point devices.

16. The method of claim 10, wherein a packet exchanged between the station device and the multiple access point devices includes a chain identifier, a received signal strength indicator, and a magnitude distance per radio chain.

17. The method of claim 10, further comprising:
detecting a change within the magnitude distance for a period of time;
determining the change within the magnitude distance is associated with a moveable obstacle to yield a determination; and
adjusting the location determined for the station device based on the determination.

18. The method of claim 10, further comprising:
determining a distance of the station device based on the magnitude distance rather than a position of one or more troughs within the channel state information; and
determining a reboot event has occurred based on a shift of the one or more troughs within the channel state information.

19. A non-transitory computer-readable storage medium comprising computer-readable instructions, which when executed by a computer, cause the computer to:
for each subcarrier within a signal received by multiple access point devices in connection with a station device, determine a measurement of channel state information including an overall shape of the signal;
determine a magnitude distance for each subcarrier, wherein the magnitude distance is a total length of a magnitude curve for all subcarriers; and
determine a location of the station device based on a fit of the magnitude distance to a model, wherein the model is based on an environment with one or more obstacles causing an obscuration of the signal.

20. The non-transitory computer-readable storage medium of claim 19, wherein execution of the computer-readable instructions further cause the computer to:
position the multiple access point devices on a floor map, wherein a location for each AP device is known and recorded, wherein each access point device receives one or more frames from other access point devices within the multiple access point devices;
determine the magnitude distance from the one or more frames; and
construct a fingerprinting model by recording the magnitude distance, wherein the magnitude distance is correlated with an environment represented by the floor map.

21. The non-transitory computer-readable storage medium of claim 19, wherein execution of the computer-readable instructions further cause the computer to:
inject the signal into a learning model that determines, for each AP device with a known location, which combination of received signal strength indicators and magnitude distances were recorded as the station device moved locations within a floor map;
determine that one or more troughs within the signal correspond to loss of signal strength from an obscuring object within the floor map; and
construct a prediction of a location of the station device at another environment based on how the magnitude distances and the received signal strength indicators change with changing station device locations.
